(19) United States
(12) Patent Application Publication
(10) Pub. No.: US 2022/0116749 A1
(43) Pub. Date: Apr. 14, 2022

(54) Method For Managing Wirelessly Incoming Messages On A Device Or Messages Generated By A Unit Of The Device, And Motor Vehicle

(71) Applicant: Volkswagen Aktiengesellschaft, Wolfsburg (DE)

(72) Inventor: Sebastian Ehmann, Wolfenbüttel (DE)

(73) Assignee: Volkswagen Aktiengesellschaft, Wolfsburg (DE)

(21) Appl. No.: 17/496,036

(22) Filed: Oct. 7, 2021

(30) Foreign Application Priority Data
Oct. 8, 2020 (DE) 10 2020 212 794.8

(51) Int. Cl. H04W 4/12

(52) U.S. Cl. CPC H04W 4/12; G06F 3/167

(57) ABSTRACT

The invention relates to a method for managing wirelessly incoming messages on a device, or messages generated by a unit of the device, wherein such an incoming message, or message generated by a unit of the device, is checked according to a predetermined criterion for relevance to a particular person, and wherein the message is only output when relevance is thereby established and, when irrelevance is thereby established, instead the mere presence of the message is signaled.

### CROSS-REFERENCE TO RELATED APPLICATIONS

This application claims priority to German Patent Application No. DE 10 2020 212 794.8, filed on Oct. 8, 2020 with the German Patent and Trademark Office. The contents of the aforesaid Patent Application are incorporated herein for all purposes.

### TECHNICAL FIELD

The present invention relates to a method for managing wirelessly incoming messages on a device, or message generated by a unit of the device, wherein such an incoming message, or messages generated by a unit of the device, is checked according to a predetermined criterion for relevance to a particular person.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

Methods are used for displaying of messages in motor vehicles. For example, a method for the selective display of messages provides that these messages are transmitted to the motor vehicle depending on the vehicle's operating situation. For example, a longer message that is displayed in slower driving cannot be displayed in a fast-driving motor vehicle.

Furthermore, another method provides that incoming messages are assigned a priority value, and in which messages are displayed on a display of the vehicle in a sequence predetermined by the priority.

The disadvantage of these methods is that the messages are generally managed in very complicated ways, which may be an issue in particular when there are very many messages.

### SUMMARY

A need exists to provide a way in which messaging is generally easier to handle.

The need is addressed by a method and a vehicle according to the independent claims. Embodiments of the invention are described in the dependent claims, the following description, and the drawings.

### BRIEF DESCRIPTION OF THE DRAWINGS

FIG. 1 schematically illustrates a motor vehicle according to an embodiment; and

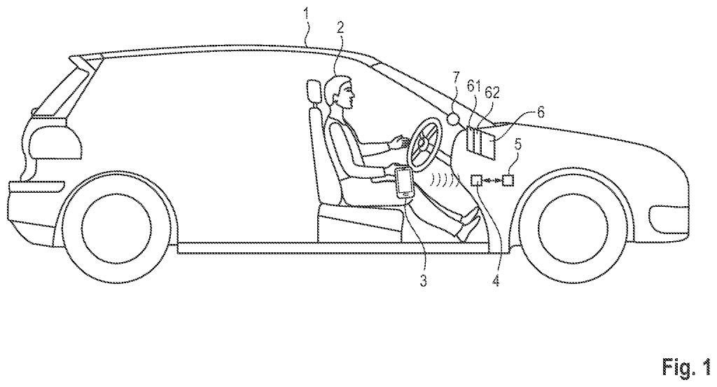

FIG. 2 illustrates an embodiment of a method for managing wirelessly incoming messages.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

In some embodiments of a method for wirelessly incoming messages, a message is output only when the relevance of the message is established, otherwise, the mere presence of the message is signaled in the event of irrelevance. Alternatively and in some embodiments, it is possible to completely suppress the irrelevant message.

Filtering is therefore offered that helps the owner of the device to deal with a large number of messages even in stressful situations.

The relevance or irrelevance may in some embodiments be established by using a pool of available character strings. Such character strings may contain keywords like “appointment,” “meeting”, “get-together”, for example together with misspellings, i.e., the same word with spelling errors. For example, the character strings may be a direct part of the text message or derived from a voice message by voice recognition before they are compared with the character strings from the pool. The character strings may moreover contain times: Messages that refer to specific time intervals may be preferred. In this case and in some embodiments, a plurality of times as alternatives to the character string may be checked for a certain time span. For example: For a relevant time span of 9:00 a.m. to 9:05 a.m., the characters 9:00, 9:01, 9:02, 9:03, 9:04 and 9:05 could for example be provided as detectors for the relevance or irrelevance of the message. Alternatively and in some embodiments, the times may be recognized differently than by using character strings, for example by using markers in the message itself (link to the meeting that may be transferred to the calendar, etc.).

In some embodiments, the method includes that the messages are received or generated in a device that is coupled to the display and/or a voice response circuit of a motor vehicle (also referred to as ‘voice response unit’ herein). The motor vehicle itself may check for relevance or irrelevance before the message is output on the display and/or the voice response circuit, or the mere presence of the message is signaled in the event of irrelevance.

The device may in some embodiments be a mobile device that is, e.g., located in the vehicle. The device may for example be a mobile phone, a smart phone, a smart watch, smart glasses, a tablet, a phablet, or any type of computer device, without limitation. The term ‘computer device’ comprises laptops, desktops, tablets, etc. without limitation. The device may be coupled with the vehicle via a data connection, e.g., the device in some embodiments may be connected with the vehicle via WLAN or Bluetooth or similar connections. The data connection may be a wired connection (e.g., USB, Ethernet) or may be established via radio communication (e.g., Wi-Fi, Bluetooth). Furthermore, the device may be a hard-wired vehicle device capable of receiving data messages via radio communication and capable of forwarding the messages via hardwired or radio communication. For example, the device may be an (integral) component of the vehicle.

When the device is coupled to a motor vehicle, it may in some embodiments be provided that, in the case of irrelevance, the mere presence of the message is signaled by the device to which a signal is correspondingly sent by the motor vehicle.

Alternatively or in addition and in some embodiments, it is possible in the motor vehicle for the display and/or the voice response circuit of the motor vehicle itself to signal the presence of the message, but in such a way that the content of the message is not deducible (so that the vehicle driver is not distracted by overly complex content).

Alternatively or in addition and in some embodiments, the mere presence of the message is signaled by an apparatus of the motor vehicle different from the display and/or the voice response circuit of the motor vehicle which outputs optically, acoustically and/or haptically perceptible signals. Whereas longer texts may be displayed on a main display of the motor vehicle, a lamp may shine on a small display, or a minimum text is offered in the dashboard (“message available” or the like).

Some embodiments pertain to a motor vehicle that has an interface with an external device which receives wireless messages and/or generates messages so that these messages may be transmitted to the motor vehicle by the device. The motor vehicle may comprise a checking circuit (also referred to as ‘evaluation circuit’ herein) that checks a transmitted message for relevance to a certain person according to a predetermined criterion and controls a signaling circuit of the motor vehicle that, in the present case, causes the message to be output only when relevance is thereby established and, when irrelevance is thereby established, instead the mere presence of the message is signaled in the event of irrelevance.

In some embodiments, corresponding information may be transmitted to the external device via the interface in the case of irrelevance so that this signals the presence of the message.

The relevance or irrelevance may in some embodiments be established by using a pool of available character strings, wherein means may for example be provided in the motor vehicle for changing the pool of available character strings. For example, by means of artificial intelligence (i.e., using an AI processing circuit), it may accordingly be learned when the user/vehicle driver actually retrieves the messages. This may apply both to messages with established relevance if, for example, the vehicle driver drives to an edge of the road to carefully study a displayed message, or if he follows the content of a message and for example transfers an appointment to his calendar, or approaches a new navigation goal that is mentioned to him in the message (usable for example for taxi drivers).

In some embodiments, it is provided that an input (device) is provided in or on the motor vehicle for confirming and/or rejecting the establishment of relevance or irrelevance of a message. When this input is actuated, the pool of available character strings is adapted. This may include clicking away a message established as relevant, or the motor vehicle driver nonetheless retrieves a message when its presence is displayed and makes corresponding entries. The benefit of this is that the messages may be evaluated, for example by more complex intelligence in the motor vehicle, in a way in which they could not be in the device itself.

Reference will now be made to the drawings in which the various elements of embodiments will be given numerical designations and in which further embodiments will be discussed.

In the exemplary embodiments described herein, the described components of the embodiments each represent individual features that are to be considered independent of one another, in the combination as shown or described, and in combinations other than shown or described. In addition, the described embodiments can also be supplemented by features of the invention other than those described.

Specific references to components, process steps, and other elements are not intended to be limiting. Further, it is understood that like parts bear the same or similar reference numerals when referring to alternate FIGS. It is further noted that the FIGS. are schematic and provided for guidance to the skilled reader and are not necessarily drawn to scale. Rather, the various drawing scales, aspect ratios, and numbers of components shown in the FIGS. may be purposely distorted to make certain features or relationships easier to understand.

The method discussed herein is applicable to any type of device in which wireless messages are received, but it is also applicable to messages generated by a unit of the device that may be managed by another unit. For example, one application is that the device is coupled to another device and a message generated by the device or received thereby is processed by the other device. To accomplish this, a smart phone may for example be coupled wirelessly or by cable to an infotainment system of a motor vehicle. The invention is however not restricted to this application but rather for example also relates to the coupling of a smartphone to a notebook or laptop or, instead of a smartphone, a smartwatch is coupled to an infotainment system of a motor vehicle or other data processing apparatuses such as notebooks and laptops.

A motor vehicle 1 is controlled by the motor vehicle driver 3 who carries a smart phone 3 that is coupled via an interface 4 to the motor vehicle 1 so that incoming text and/or voice messages to the smart phone may be transmitted to the motor vehicle where they may be evaluated by an evaluation circuit 5 by comparison with the saved character strings. Only relevant messages are output on a display 6, for example in a first region 61 thereof. Irrelevant messages are not displayed; instead only the mere presence thereof is noted, for example by signals in a second region 62 of the display 6, or by means of a signaling circuit 7 such as a lamp or a speaker.

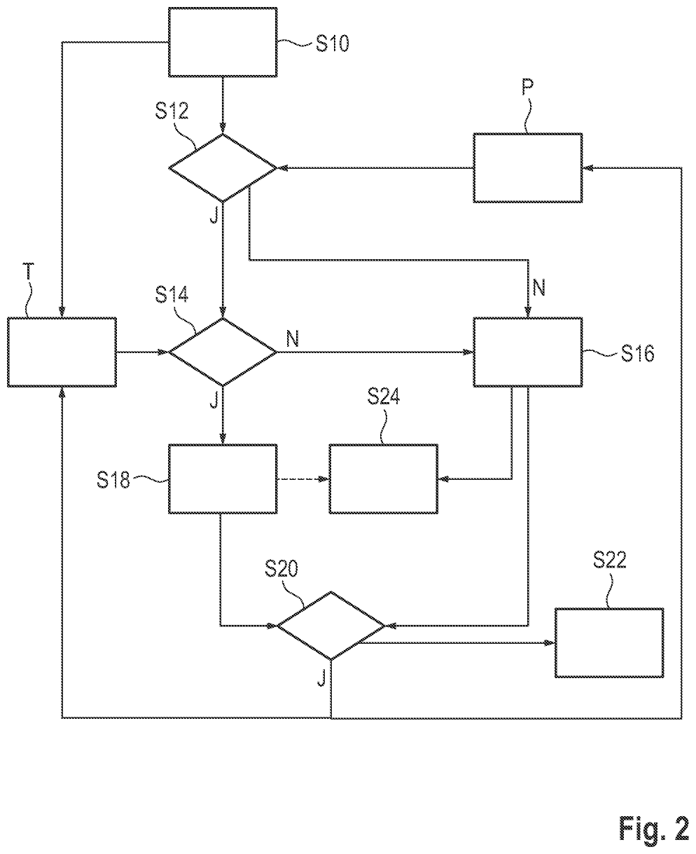

According to FIG. 2, the method begins in step S10 in that a message is present, i.e., arrives in a device and is transmitted to another device in the example. In step S12, based on a pool P of character strings, it is checked whether the message contains a character string according to the pool P. An incoming text message may be immediately analyzed. An incoming voice message is typically converted into text by means of voice recognition software, and then the text is subjected to a comparison with the character string from the pool P. The user may also have personally established such character strings beforehand, for example by using certain menu entries; in the simplest case by using certain profiles. For example, a “business profile” may include that messages which contain terms such as “meeting” and the like are preferably forwarded. With a “private” profile, such messages are contrastingly to be suppressed, etc.

Subsequently, it is checked in step S14 whether a message should be privileged according to a time scheme (represented by a symbol “T” in the FIG.). For example, it may be taken into account in the time scheme when a message was last received in step S10, if applicable also a message from the same user, wherein it may also be checked how the user reacted to this message. Accordingly, a message may be privileged if mutual communication already occurred within the last ten minutes (for example within a predetermined or chosen time span between two minutes and 24 hours, etc.). In the event that message irrelevance is recognized in step S12, a switch to step S16 occurs. A switch to step S16 also occurs in the event that the irrelevance is recognized in step S14. In step S16, the presence of the message is just signaled, for example by a sound sequence through an acoustic output apparatus, a flashing lamp, etc. If, by using the pool P and by using the time scheme T, the check has revealed that the message is relevant, it is contrastingly output in step S18. Steps S16 and S18 are always followed by step S20 which checks whether or not the vehicle driver has confirmed by any reaction (for example by selecting a telephone number of a sender of a message), or has not confirmed by any reaction that rating the message relevant or irrelevant was justified. If such an entry is made, the pool P is for example adapted by self-learning artificial intelligence, or also the time scheme T.

In the FIG., the check for a matching time scheme T in step S14 follows step S12 of the check using the character string P. In this case, the sequence may also be reversed, or respectively parallel processing may occur. Moreover, there may also be a check of the time details using character strings, for example the numeric reproduction of times. If there is no reaction by an input device, there is a switch to step S22, and the method concludes.

Proceeding both from step S16 and step S18, optionally a step S24 may be performed in which there is a response to a sender of the message. For example, the artificial intelligence or another data processing apparatus of the motor vehicle may transmit a signal to the device/smartphone/smartwatch, etc. coupled to the motor vehicle, so that this in turn notifies the sender. The signal from the motor vehicle to the coupled device may simply trigger the response to the sender, or already specify the message to be transmitted.

### LIST OF REFERENCE NUMERALS

1 Motor vehicle

2 Motor vehicle driver

3 Smartphone

4 Interface

5 Evaluation circuit

6 Display

61 First range of the display 6

62 Second range of the display 6

7 Signaling circuit

S10, S12, S14, S16, S18, S20, S22, S24 Steps of a method

P Pool of character strings

T Time scheme

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for managing wirelessly incoming messages on a device, or messages generated by a circuit of the device, comprising:
checking an incoming message or a message generated by the circuit of the device according to a predetermined criterion for relevance to a particular person;
outputting the message only when relevance is established; and
in case irrelevance is established, signaling the presence of the message.

2. The method of claim 1, wherein the relevance or irrelevance is established by using a pool of available character strings.

3. The method of claim 1, wherein the messages are received or generated in one or more of a device that is coupled to a display and a voice response circuit of a motor vehicle, wherein the relevance or irrelevance is checked by the motor vehicle.

4. The method of claim 3, wherein in the case of irrelevance, a signal is sent to the device which then provides a signal of the presence of the message.

5. The method of claim 3, wherein in the case of irrelevance, the presence of the message is signaled by one or more of the display and the voice response circuit of the motor vehicle itself such that the content of the message is not deducible.

6. The method of claim 3, wherein in the case of irrelevance, the presence of the message is signaled by an apparatus of the motor vehicle different from the display and the voice response circuit of the motor vehicle which outputs optically, acoustically and/or haptically perceptible signals.

7. A motor vehicle that has an interface with an external device which receives wireless messages and/or generates messages, so that these messages may be transmitted to the motor vehicle by the device, wherein the motor vehicle comprises an evaluating circuit that is configured to check a transmitted message for relevance to a certain person according to a predetermined criterion and to control a signaling circuit of the motor vehicle that causes the message to be output only when relevance is established, and when irrelevance is established, the presence of the message is signaled.

8. The motor vehicle of claim 7, wherein the relevance or irrelevance is established by using a pool of available character strings, wherein the pool of available character strings is changeable.

9. The motor vehicle of claim 8, comprising an input for confirming the establishment of relevance or irrelevance of a message, wherein when the input is actuated, the pool of available character strings is adapted.

10. The motor vehicle of claim 7, wherein corresponding information is transmitted to the external device via the interface in the case of irrelevance so that this external device signals the presence of the message.

11. The method of claim 2, wherein the messages are received by or generated in one or more of a device that is coupled to a display and a voice response circuit of a motor vehicle, wherein the relevance or irrelevance is checked by the motor vehicle.

12. The method of claim 11, wherein in the case of irrelevance, the presence of the message is signaled by one or more of the display and the voice response circuit of the motor vehicle itself such that the content of the message is not deducible.

13. The method of claim 12, wherein in the case of irrelevance, the presence of the message is signaled by an apparatus of the motor vehicle different from the display and the voice response circuit of the motor vehicle which outputs optically, acoustically and/or haptically perceptible signals.

14. The motor vehicle of claim 8, wherein corresponding information is transmitted to the external device via the interface in the case of irrelevance so that this external device signals the presence of the message.

15. The motor vehicle of claim 9, wherein corresponding information is transmitted to the external device via the interface in the case of irrelevance so that this external device signals the presence of the message.
